(19) United States
(12) Patent Application Publication
(10) Pub. No.: US 2024/0281584 A1
(43) Pub. Date: Aug. 22, 2024

(54) PHYSICAL LAYOUT SYNTHESIS FOR STANDARD CELLS USING SLICE LAYOUTS

(71) Applicant: Applied Materials, Inc., Santa Clara, CA (US)

(72) Inventors: Martinus Maria Berkens, Eindhoven (NL); Bhuvaneshwari Ayyagari, Cupertino, CA (US); Simon Johannes Klaver, Weert (NL); Vinod Reddy, San Jose, CA (US); Rene Gerardus Maria Beugels, Eindhoven (NL); Andres Llopis Lozano, Majadahonda (ES)

(73) Assignee: Applied Materials, Inc., Santa Clara, CA (US)

(21) Appl. No.: 18/170,335

(22) Filed: Feb. 16, 2023

(51) Int. Cl. G06F 30/337; G06F 30/392

(52) U.S. Cl. CPC G06F 30/337; G06F 30/392

(57) ABSTRACT

A method of automatically generating standard cells may include receiving a definition of a circuit for a standard cell. The definition may include one or more semiconductor devices. The method may also include identifying a plurality of slices that implement a device in the one or more semiconductor devices. Each of the plurality of slices may include a partial layout for the device. The method may further include combining more than one of the plurality of slices into a combined layout to implement the device when forming the standard cell.

### TECHNICAL FIELD

This disclosure generally describes a synthesis process for generating standard cells used in front-end-of-line (FEOL) processes. More specifically, this disclosure describes using device slices that are combined to implement a circuit definition to automatically generate a standard cell for a standard cell library.

### BACKGROUND

Circuit architectures over the past several decades have used scaling techniques to meet the demands of ever-increasing workloads. Scaling traditionally reduces the feature size of integrated circuit elements (e.g., from 10 nm, to 7 nm, to 5 nm, and so forth). However, in recent years the physical limitations of silicon structures have dramatically slowed the gains that may be made from scaling techniques as the limitations of physics are reached. Additionally, with the recent emergence of artificial intelligence and machine learning algorithms (AI/ML), the amount of data to be processed and the diversity of different workload types are beginning to overtake the gains that can be made by scaling technologies. The hardware compute requirements are growing exponentially, and new circuit fabrication advances may be required to maintain this pace. The increasing processing demands from AI/ML technologies, combined with the decreasing performance gains realized through traditional circuit scaling may require alternative techniques to improve performance. Therefore, improvements are needed in design methodologies, including the generation of standard cell libraries.

### SUMMARY

In some embodiments, a method of automatically generating standard cells may include receiving, by a computer system, a definition of a circuit for a standard cell. The circuit may include one or more semiconductor devices. The method may also include identifying, by the computer system, a plurality of slices that implement a device in the one or more semiconductor devices. Each of the plurality of slices may include a partial layout for the device. The method may additionally include combining, by the computer system, more than one of the plurality of slices into a combined layout to implement the device when forming the standard cell.

In some embodiments, a system may include one or more processors and one or more memory devices comprising instructions that, when executed by the one or more processors, cause the one or more processors to perform operations including receiving a definition of a circuit for a standard cell. The circuit may include one or more semiconductor devices. The operations may also include identifying a plurality of slices that implement a device in the one or more semiconductor devices. Each of the plurality of slices may include a partial layout for the device. The operations may additionally include combining more than one of the plurality of slices into a combined layout to implement the device when forming the standard cell.

In some embodiments, one or more non-transitory computer-readable media may store instructions that, when executed by one or more processors, cause the one or more processors to perform operations including receiving a definition of a circuit for a standard cell. The circuit may include one or more semiconductor devices. The operations may also include identifying a plurality of slices that implement a device in the one or more semiconductor devices. Each of the plurality of slices may include a partial layout for the device. The operations may additionally include combining more than one of the plurality of slices into a combined layout to implement the device when forming the standard cell.

In any embodiments, any and all of the following features may be implemented in any combination and without limitation. The device may include a functional circuit element. The partial layouts may not be functional circuit elements, and the combined layout may form the functional circuit element. A slice in the plurality of slices may include partial layouts for more than one of the one or more semiconductor devices, and the combined layout may include additional slices that together with the more than one of the plurality of slices implement the one or more semiconductor devices for the standard cell. A first slice in the plurality of slices may include a first partial layout for the device, and a second slice in the plurality of slices may include a second partial layout for the device. The device may be a transistor or a diode. The first partial layout ma include a layout of a source region or a drain region of a transistor. The second partial layout may include a layout of a gate region of a transistor. The plurality of slices may include a first set of slices that each includes a different implementation of a first partial layout for the device, and the method/operations may further include selecting a first slice from the first set of slices for the device. The first slice may include a connection to a first intersecting track in a metal layer, and a second slice may include a connection to a second intersecting track in the metal layer. The method/operations may also include determining one or more device chains for generating a cell layout for the standard cell. The one or more device chains may represent connections between devices in the one or more semiconductor devices and inputs and/or outputs in the standard cell. The method/operations may also include selecting a set of candidate slices from a slice library that can be used to implement each of the connections. The method/operations may further include assigning tracks in a metal layer to the inputs/outputs in the standard cell; optimizing the set of candidate slices by eliminating slices that can be implemented by placing two slices adjacent to each other; and optimizing the set of candidate slices by eliminating slices that have conflicting connections to the tracks in the metal layer. The method/operations may also include generating one or more combinations of slices from the set of candidate slices that each implement the standard cell. The method/operations may also include optimizing the one or more combinations of slices based on design rules for the metal layer. The one or more combinations of slices may include the plurality of slices for the device after optimization. The definition of the circuit may include a netlist with device characteristics and connections between the one or more semiconductor devices. The method/operations may also include accessing a first slice library for the device to retrieve the plurality of slices. The first slice library may include partial layouts for different implementations of a first device type for the device. A second slice library for the device, may include partial layouts for different implementations of a second device type for the device. The device may include a transistor, the first device type may include a metal-oxide-semiconductor field-effect transistor (MOSFET), and the second device type may include a fin field-effect transistor (finFET).

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a simplified integration flow or the synthesis of a standard cell, according to some embodiments.

FIG. 2 illustrates a schematic for an inverter design for standard cell, according to some embodiments.

FIG. 3 illustrates an example of a set of SD slices used to implement the source/drain region of a transistor with corresponding connections, according to some embodiments.

FIG. 4 illustrates an example of a set of gate slices used to implement the gate region of a transistor with corresponding connections, according to some embodiments.

FIG. 5 illustrates a complete layout for a standard cell generated from device slices, according to some embodiments.

FIG. 6 illustrates a schematic of a circuit used for a NAND2 standard cell, according to some embodiments.

FIG. 7 illustrates possible device chains that may be derived from the circuit, according to some embodiments.

FIG. 8 illustrates candidate gate slices that may be used to implement the selected transistor chains, according to some embodiments.

FIG. 9 illustrates candidate SD slices that may be used to implement the selected transistor chains according to some embodiments.

FIG. 10 illustrates a flowchart of a method of automatically generating standard cells, according to some embodiments.

FIG. 11 illustrates a flowchart of operations that may be used to select and optimize a set of slices used to implement the standard cell, according to some embodiments.

FIG. 12 illustrates an exemplary computer system, in which various embodiments may be implemented.

### DETAILED DESCRIPTION

Circuit architectures over the past several decades have used scaling techniques to meet the demands of ever-increasing workloads. Scaling traditionally reduces the feature size of integrated circuit elements (e.g., from 10 nm, to 7 nm, to 5 nm, and so forth). However, the physical limitations of silicon structures have dramatically slowed the gains that may be made from scaling techniques in recent years. Additionally, with the recent emergence of artificial intelligence and machine learning algorithms (AI/ML), the amount of data to be processed and the diversity of different workload types are beginning to overtake the gains that can be made by scaling technologies. Hardware compute requirements are growing exponentially, and new circuit fabrication advances may be required to maintain this pace. Therefore, the increasing processing demands from AI/ML technologies, combined with the decreasing performance gains realized through traditional circuit scaling may require alternative techniques to improve performance. One such alternative technique for improving performance is materials/process innovation by equipment manufacturers.

Materials innovation includes, for example, any change to the various physical aspects of a semiconductor device, such as the size of a source/drain contact, types of isolation between transistors, gate oxide materials, work function metals, doping in source/drain regions, contact materials, liners in the contact materials, and/or any other parameters of a semiconductor device. The impact of these types of changes on large processors and/or Systems-on-Chip (SoCs) with different software algorithms may not be clear at the early stage of the semiconductor design cycle. For example, the Power-Performance-Area-Cost (PPAC) improvements of the material engineering innovation may seem small, but may be multiplied dramatically at an SoC level, or vice-versa.

Despite the promising gains that may be made by materials innovation, difficulties and inherent limitations with existing tools, processes, and systems make material innovations difficult to realize in practice without an extensive, multi-year design validation process. Because of the complexity inherent in designing, testing, implementing, and producing complex circuit-based systems, the design process has traditionally been split between different entities in the semiconductor ecosystem. For example, a material or process change at the semiconductor level would be introduced using by an equipment manufacturer. The material change would then later be implemented in simple device structures with compact models at a semiconductor fabrication plant or foundry. Process design kits (PDKs), Standard Cells libraries, and embedded memories for a process design kit (PDK) were developed by integrated circuit design entities providing electronic design automation (EDA) software. The standard cells/memories in the PDK we used by a “fabless” device design entities or integrated device manufacturers (IDMs) to generate block level designs, full SoCs, and system-level devices. Finally, software designers would use the manufactured IC devices to run complex software designs and algorithms. Each of these different stages of the IC design and manufacturing pipeline was executed by different entities, each of which used different software/hardware tools to perform their portion of the process.

Simple devices and/or compact models designed by the foundry are tested against their own internal benchmarks to determine that the corresponding simple circuit device meets their technical requirements. The simple devices and/or compact models would then be passed to the integrated circuit (IC) design entity, which would use the compact models to design full a PDK, Standard Cells, and memory cells for the EDA software. The IC design entity would test the standard cells against their own internal technical requirements. Finally, the standard cells would be used to design full IC systems, which would again be tested against their own software benchmarks. Therefore, it is often very difficult to see the effect of a change in the standard cells for basic functional devices, such as transistors, diodes, and so forth, once these devices are integrated into full processing systems.

One of the main bottlenecks in testing new designs involves the generation of standard cells libraries for example, standard cells are traditionally designed and propagated through a multi-step process. After the compact models representing functional devices (e.g., transistors) are generated, the compact models can be used to build a circuit for a standard cell. This step may be executed by the device fabricator and/or the integrated circuit design entity. For example, when combining compact models of individual transistors together, additional aspects of the circuit performance may be impacted based on the connections between these transistors. Capacitances and dielectrics many be formed between compact model transistors as they are combined together into a larger, multi-transistor circuit. Therefore, at this level, the standard cells are usually designed in the EDA software and tested at the circuit level rather than at the transistor level. For example, standard circuits can be benchmarked against power consumption, frequency, and/or other simple electrical characteristics. As described above, material/process changes may affect the operation of the standard cells, but these effects would not be discovered until the material/process changes had propagated down to the IC design entity during simulation and use of the EDA software, SPICE simulations, etc.

One of the most time-consuming aspects of the process was generating full PDK libraries and standard cells. The PDK libraries may include symbols, device parameters, parametric cells, design rules, layout versus schematic rules, electrical rules, layers, and so forth. When material/process changes are made by the equipment manufacturer, the PDK libraries comprising standard circuit elements and cells are generally redesigned by the device fabricator and/or IC design entity. This is a mostly manual time-consuming process since standard cell libraries contain up to thousands of cells for which layout has to be drawn, and electrical properties like power and delay have to be simulated. Reducing the library size to save effort is not a valid option since it reduces the accuracy of a subsequent PPA assessment.

Testing experiments for standard cells used to be performed using simple and small electronic circuits, such as a ring oscillator. However, a technical problem in this area has developed in recent years wherein using these simple circuits can no longer quickly and accurately provide a performance, power, and cost (PPA) assessment. In order for a proper assessment to be conducted, more realistic circuits are needed beyond the simple ring oscillator. Therefore, proper testing may now require the full creation of a standard cell library. The physical layouts for the logic circuits in the standard cell library can be assembled by the EDA tools (e.g., Place & Route tools) to create complex designs that provide more realistic PPA characterizations. However, for advanced technologies, generating standard cell libraries is currently done manually by circuit designers, thus representing a major bottleneck in the DTCO cycle.

The embodiments described herein solve this technical problem and other technical problems by automatically synthesizing standard cell libraries in a fully automated fashion. These embodiments preserve the flexibility that is needed to cope with various technology variations while preserving the quality of the layout that is needed in order to generate realistic PPA assessments. These improvements operate by further breaking down the building block devices for the standard cell into partial layouts referred to herein as slices. The tool may then be configured to optimize a selection of slices that are used to construct the combined devices in the standard cell.

Prior to this disclosure, attempts to synthesize standard cells in an automated fashion were problematic. Each of these previous solution attempts essentially utilized two steps in the cell synthesis process: (1) placing individual transistors (e.g., NMOS and PMOS transistors) in rows at the bottom and top of the cell area, and then (2) routing the transistor nodes to the circuit terminals. Typically in these previous attempts was the fact that each of the designs for the transistors and/or other devices were complete and distinct functioning devices. In other words, each fundamental device, such as a transistor, a diode, and so forth, that was used as a building block in the standard cell were themselves complete and functional circuit elements with complete geometrical layouts. The synthesis process used these complete functional blocks and assembled them together to form the standard cell. Problematic in this approach is that assembly of the complete cell layouts is very much dependent on the way these building blocks interact and need to be connected. This made it impossible to create software that is generic enough to be able to synthesize layouts for a wide variety of devices. For instance it would not be possible to perform a synthesis for a technology where NMOS and PMOS devices are represented by separate building blocks (e.g., as in a FinFET process) and to have a building block that represents joint NMOS and PMOS devices (e.g., in a CFET process) executed by the same software program.

However, as described above, it is often desirable to change the designs of these functional building blocks in order to fully test how a change affects a later system design as the change is propagated through the design process. Changing a transistor to a different type or technology (e.g., changing from a MOSFET to a finFET) required a redesign of the device model, and subsequently a manual redesign of the standard cell. Transistor types and technologies were not readily interchangeable in the standard cells without going through this time-consuming redesign process.

To solve this problem, the embodiments described herein further subdivide each device into “slices” in order to represent transistors and other devices in a fundamentally different way. In this different representation, the actual layout for devices is abstracted for the software in the slices. The software does not need to be aware of that layout or the technology details; it only needs to know, starting at first BEOL interconnect layer, were to connect to the device terminals (e.g., a transistor source, drain or gate). For example, slices for a transistor may include vertical cross-sections of the layout representing possible locations and connections for a key positions. As described in greater detail below, each slice may define a layout for more than one device such that the slices can be readily used to form device chains or device pairs. For example, forming a transistor pair may use three slices (e.g., one for the source, one for the gate, and one for the drain). The final standard cell layout is not made by placing individual transistors followed by routing as in previous methods, but instead is generated by placing a sequence of slices followed by the routing. The advantage of this technique is that many of the manufacturing and design details are hidden inside of the slices, and the standard cell generation tool or synthesis tool can work generically with slices without requiring any detail or understanding of the underlying slice design. This abstraction of the slice detail allows the tool to work generically with a variety of device technology options. For example, instead of redesigning a standard cell with the transistor placement when moving from a MOSFET to a finFET, CFET, or stacked 3D transistor configuration, these options can be provided to the tool, which may automatically select the appropriate slices and create the layout for the standard cell using the techniques described below. This tool may include a computer program that reads a definition of a circuit for standard cell, creates one or more device chains (e.g., transistor chains of NMOS and/or PMOS transistors), selects a sequence of slices to implement those device chains comprising alternating gate and source/drain matches, and routes the connections needed by the slices to implement the final layout for the standard cell. Each of these steps may be performed automatically by the tool without requiring any human intervention.

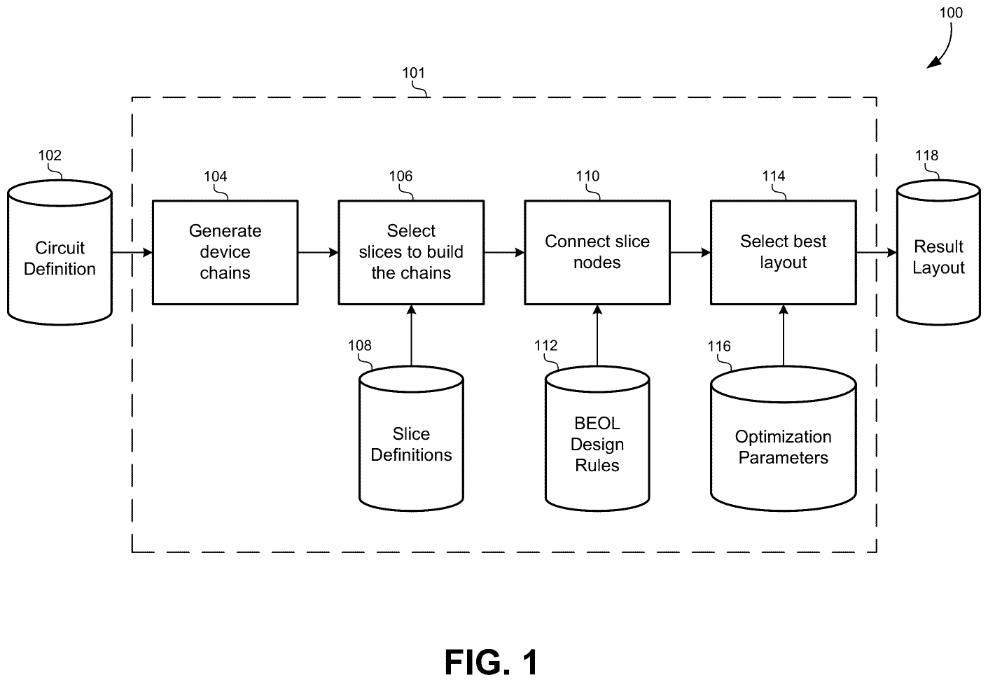

FIG. 1 illustrates a simplified integration flow 100 for the synthesis of a standard cell, according to some embodiments. A tool 101 may be configured to perform many of these operations. The tool 101 may be implemented as a set of instructions stored on one or more non-transitory computer-readable media. This may include a single set of instructions stored in an instruction memory, or may also include distributed instruction sets that each execute a portion of this method on different processors and/or computing systems. These instructions may be executed by one or more processors co-located or distributed in any fashion to perform the operations described below.

The tool may receive a definition of a circuit for a standard cell 102. The definition of the circuit for the standard cell 102 may be provided in any format, such as a netlist of devices. For example, some embodiments may use the .CDL file type that defines the circuit netlist in a Circuit Definition Language. The circuit for the standard cell may be designed using any computer-aided design (CAD) software tool.

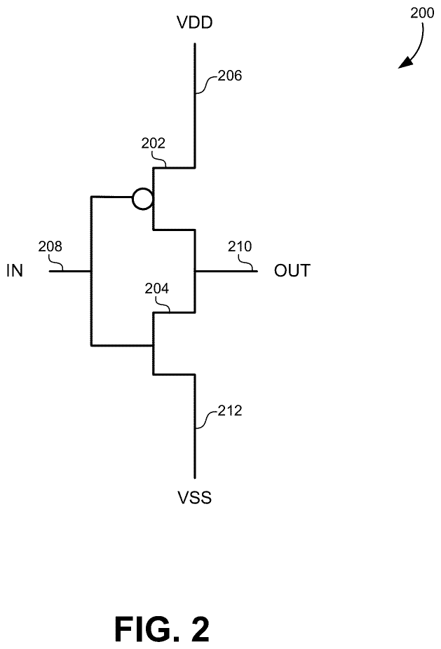

FIG. 2 illustrates a schematic for an inverter 200 design for standard cell, according to some embodiments. The inverter 200 may include I/O connections that form the interface of the standard cell. For example, the inverter 200 may include a VDD connection 206, and IN connection 208, an OUT connection 210, and a VSS connection 212. Additionally, the inverter 200 may include a number of devices, such as a PFET 202 and an NFET 204. The CAD software tool may allow the circuit designer to build the inverter 200 or other standard cell from building block devices such as the PFET 202 and the NFET 204, that are wired together in the CAD software. An example of a definition of a circuit for the standard cell 102 of the inverter may include the following netlist.

.SUBCKT Invertor IN OUT VSS VDD
M0 VDD IN OUT VDD pfet W=1.0 L=1.0 nfin=2
M1 VSS IN OUT VSS nfet W=1.0 L=1.0 nfin=2
.ENDS

As used herein, there is a distinction between the terminology of a “standard cell” and a “device” used as a building block for the standard cell. In this example, the inverter 200 may be considered the standard cell, and the PFET 202 and the NFET 204 may each be considered a device used as a building block for the standard cell. A standard cell will typically include a plurality of individual devices used as building blocks that are wired together. A device may typically be a single functional circuit element that is placed using the CAD software tool. A device also may be characterized as a functional circuit element, such as a transistor or diode, where placing connections to available ports or I/O connections on the device would result in a functional circuit element performing its intended function, such as operating as a transistor switch, regulating current flow, scaling voltage, etc., depending on the device type. Typically, a device may be defined as a functional block in the CAD software tool. For example, the PFET 202 and the NFET 204 devices in the inverter 200 are defined in the netlist as M0 and M1 transistor devices. Characteristics of these transistor devices may also be included in the netlist, such as a width, length, and/or other physical device characteristics.

Turning back to FIG. 1, the definition of the circuit for the standard cell 102 may be passed to the tool 101, and the tool 101 may proceed to automatically synthesize the definition of the circuit for the standard cell 102 into a result 118 or full circuit layout for the standard cell. First, the tool 101 may generate device chains 104 that implement the circuit for the standard cell. A device chain may represent a sequence for connecting a plurality devices that are represented in the standard cell. For example, a transistor chain may include a sequence of connections between transistors in the standard cell. This sequence of connections may be used to efficiently layout transistors that are chained together through connections or adjacency in the circuit definition. For example, the PFET 202 and the NFET 204 may be laid out such that the drain of the PFET 202 is adjacent to the drain of the NFET 204, thereby forming an inherent connection. Additionally, the chains of devices may be determined such that the source/drain of one device is shared with the source/drain of a other device if they are connected to the same electrical node. This approach saves area on the resulting chip. As described in greater detail below, the tool 101 may generate a list of possible device chains that may be used to implement the standard cell, and then may select an optimal device chain from the list of possible device chains.

Traditionally, the standard cell would be built directly from device layouts for each device in the device chains. However, the embodiments described herein include a number of additional processes or operations that optimize the synthesis of the standard cell by using partial layouts referred to as “slices” instead of full device models. After generating one or more device chains to implement the standard cell, the tool 101 may identify a plurality of slices that implement the combination of devices in the device chains 106. The slices selected by the tool 101 may be retrieved from a library of slice definitions 108.

As used herein, there is a distinction between the terminology of a “device” used as a building block for the standard cell and a “slice” used as a building block for devices. Generally, a slice may not be a functional circuit element, but rather may include partial layouts for a device, such as a transistor. For example, a first slice may include a partial layout for a device that includes a layout of a source region and a drain region for a transistor, without including layouts for connections for a gate region. A second slice may include a partial layout for the gate region. A gate slice may define the geometries that define the gate layout and how gates may be connected to overlying metal layers. Similarly, source/drain (SD) slices may define the SD layout and how the source and/or drain are connected to power, ground, signal tracks in metal layers, and so forth. The first slice defining the partial layout for the source region and drain region may be combined with the second slice defining the gate region to form a complete transistor. SD slices may also define how adjacent transistors or devices are abutted next to each other in the layout. It should be emphasized that a slice may often define a partial layout of multiple devices. For example, a single slice may define a layout for both NMOS and PMOS source/drain areas, which may be part of two different transistor devices. However, some partial layouts may be specific to only a single device. Therefore, a collection of partial layouts may be combined together to form the combined layout for multiple devices or for a single device in the standard cell.

Additionally, the library of slice definitions 108 may include a set of multiple slices for each region. For example, the library of slice definitions 108 may include a first set of slices that each include different implementations of the partial layout for the source region the drain region. The library of slice definitions 108 may also include a second set of slices that each defines different implementations of the partial layout for the gate region of the transistor. For example, slices from both of these sets may include connections to different signal tracks in the metal layer. The tool 101 may select slices from each of these sets of slices in order to provide a list of possible slices for implementing each device chain. Examples of slices and their corresponding partial layouts are described in detail below.

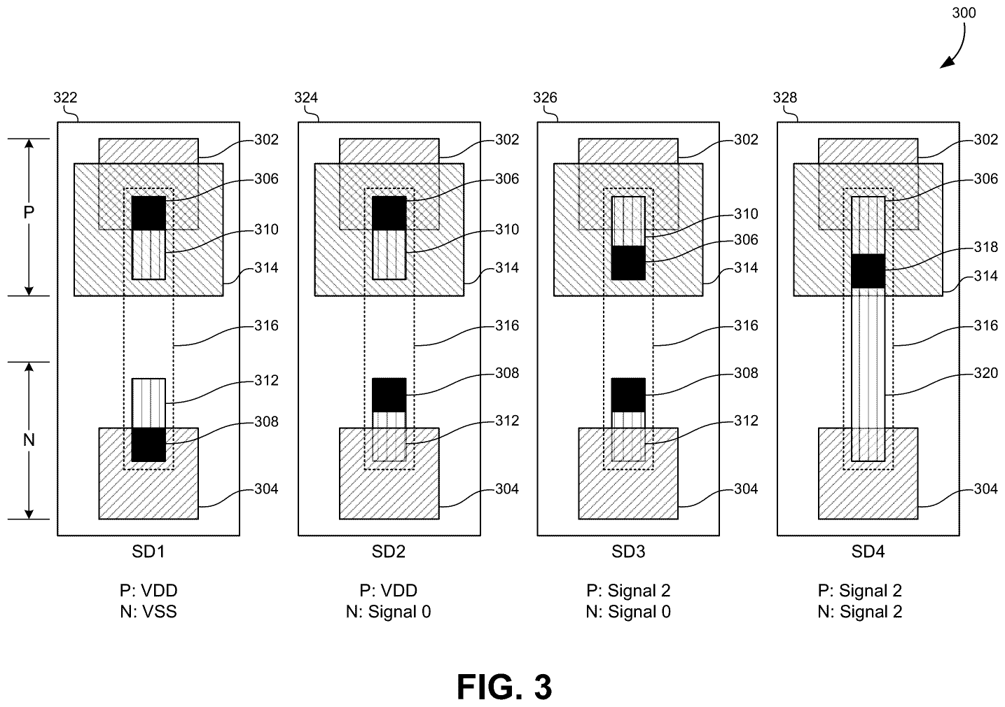

FIG. 3 illustrates an example of a set of SD slices 300 used to implement the source/drain region of a transistor with corresponding connections, according to some embodiments. Each slice in the set of SD slices 300 may include an alignment shape 316. The alignment shape 316 may be implemented as a predefined layer in the layout. The alignment shape 316 may be used to align various slices for the device. For example, the alignment shape 316 may be used to align an SD slice with a corresponding gate slice. Therefore, the alignment shape 316 may be present in each slice in the slice library for device. The alignment shape 316 may also be placed such that these rectangles are vertically aligned and/or horizontally touching in each slice, such that slices for the partial layouts of a device may be composited using the alignment shape 316 on the substrate. For example, the alignment shape 316 may be used to align shapes horizontally, such that one alignment shape abuts against an adjacent horizontal alignment shape.

Each slice in the set of SD slices 300 may also include the following features: a VDD area 302, a VSS area 304, a P source/drain (PSD) area 310, an N source/drain (NSD) area 312, an N-well 314, a PSD metal connection 306, and an NSD metal connection 308. Note that the tool 101 does not need to know any of the details of the layouts illustrated in FIG. 3 in order to synthesize the standard cell. For example, the NFET and PFET slices could easily be replaced with finFET or other transistor implementations. So long as the tool 101 knows the location of the alignment shape 316, the metal connection 306, 308 to the metal layer, and the basic purpose of the slice (e.g., a SD partial layout), the tool 101 can select slices that include the required connections for the device chain described above.

The set of SD slices 300 may include different connections for each of the source and drain regions. For example, slice 322 has the PSD metal connection 306 connected to the VDD area 302 to create a source/drain connection to VDD (e.g., through a connection such as a via). Note that the power track that includes the VDD area 302 may run above the device in a metal layer, or may run below the device in power plane in the substrate. Slice 322 also shows the NSD metal connection 308 connected to the VSS area 304 to create a source/drain connection to VSS. In another example, slice 324 shows the NSD metal connection 308 connected to a signal track in the overlying M0 metal layer instead of the connection to VSS shown in slice 322. Slice 326 shows both the NSD metal connection 308 and the PSD metal connection 306 connected to different signal tracks in the overlying M0 metal layer. Slice 328 shows both the source and drain regions connected to the same signal track in the M0 metal layer, with a connection 320 (e.g., a trench contact) between the PSD area and the NSD area and a single metal connection 318.

This set of SD slices 300 is provided only by way of example and is not meant to be limiting. For example, other slices in the set may include connections to different signal tracks in various metal layers. The tool 101 can analyze the netlist circuit definition for the standard cell and select any of the set of SD slices 300 that creates the necessary connections to the source/drain regions of the transistor. For example, for a transistor with a source connection to VDD and a drain connection to a signal, slice 324 may be selected to implement a partial layout of the transistor. This selection may be made based on the connections to the metal layers made by each of set of slices 300. Therefore, the tool 101 does not need to know how these connections are made in the partial layouts of the slices or the types of source/drain regions used. For example, when implementing a finFET, the PSD area 310 and the NSD area 312 may be replaced with horizontal fins in the slices. It should also be understood that any of the partial layouts for the slices described herein are greatly simplified, and additional layers, features, and geometries may also be present that are not explicitly shown in these figures.

The tool may also select other partial layouts needed to create the complete layout for the device. For example, in addition to selecting one or more of the SD slices, the tool 101 may proceed to select gate slices but also match the required connections in the netlist of the standard cell to implement the device chain. Thus, the tool 101 may align each of the selected slices together using the alignment shape 316 to build a full layout for the device. When building a standard cell, the slices representing partial layouts for each of the devices may be combined together to efficiently form the full layout for the standard cell.

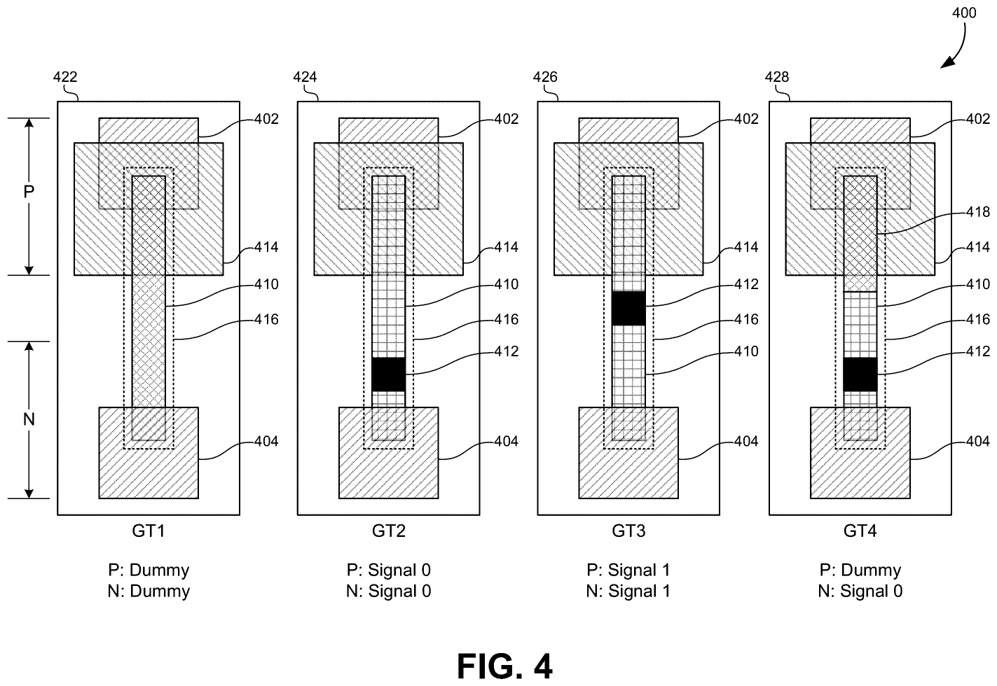

FIG. 4 illustrates an example of a set of gate slices 400 used to implement the gate region of a transistor with corresponding connections, according to some embodiments. Each of the set of gate slices 400 may implement the gate region of a transistor with different connections. These slices may include geometries for a VDD area 402, a VSS area 404, and an N-well 414 as described above for the set of SD slices 300. Additionally, the set of gate slices 400 may include a gate area 410 (e.g. a polysilicon area or a metal gate region) along with a gate metal connection 412. As described above for the set of SD slices 300, the set of gate slices 400 may also include an alignment shape 416 that may be used to align the gate slices with the SD slices when combining the two together for a device layout.

As described above for the set of SD slices 300, each of the set of gate slices 400 may include a different gate connection. For example, slice 422 may not include a connection to an upper metal layer, thereby forming a dummy gate that can be used to insulate or border areas of the standard cell using a diffusion break. Slice 424 may locate the gate metal connection 412 at the location of a first signal track in the metal layer. Slice 426 may locate the gate metal connection 412 at a second signal track in the metal layer. Slice 428 may locate the gate metal connection 412 at the first signal track, while including a gate region 418 over the PMOS area of the transistor that is disabled. This gate region 418 may be disabled using a diffusion break or other material.

The tool 101 may select the SD slices and gate slices that can be used to implement the device chain. The process for selecting the optimal SD slices and/or gate slices is described in greater detail below. Turning back to FIG. 1, the selected slices may be optimized such that one or more slice combinations are identified in order to implement the device chains. Each set of selected slices may be combined together to form a full layout for the standard cell. For example, a plurality of selected slices may be laid out adjacent to each other by horizontally and/or vertically aligning each of the slices using the alignment shapes described above. Connections that may be routed at the overlying metal layer.

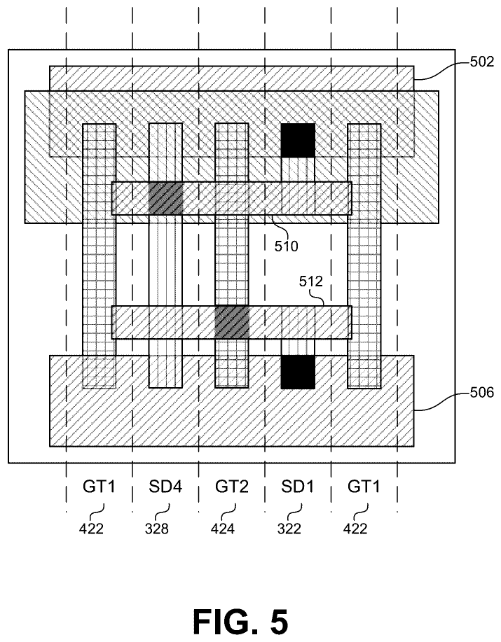

FIG. 5 illustrates a complete layout for a standard cell generated from device slices, according to some embodiments. In order to implement the standard cell, the device chain for the two transistors may be used to select a number of different slices that can be implemented efficiently in a horizontal sequence to form the inverter. For example, the dummy gates of slice 422 may be placed on either side of the standard cell. The output of the inverter may be connected to metal track 510 using slice 328. The input of the inverter may be connected to metal track 512 and implemented with gate slice 424. Finally, the VSS 506 and VDD connections 502 may be implemented using SD slice 322. These slices may be arranged horizontally next to each other such that the alignment shapes 316, 416 abut adjacently. Aligning these SD and gate slices may form inherent connections at the PSD area 310 and/or NSD area 312 described above.

Additionally, the full layout may include metal connections in the metal layer. Each of the metal tracks may be aligned horizontally relative to the gate regions in the slices. Each horizontal “track” may be used to connect an I/O signal or internal net of the standard cell. The routing of these metal layers may be determined using design rules and other routing techniques. Turning back to FIG. 1, back-and-of-line (BEOL) design rules 112 may be used to eliminate certain slices from the set of selected slices if they are incompatible with the routing rules. The BEOL design rules 112 may also be used to choose and/or connect metal tracks to the signals that are exposed in each of the slices.

The tool 101 may identify a number of different slice combinations that may be used implement the standard cell. In other words, different arrangements of slices may be used to generate different implementations of the standard cell by arranging transistors differently, using different metal tracks or signals, and so forth. In some cases, one of the slice combinations may be chosen and used to synthesize the standard cell. In other cases, each of the slice combinations may be used to synthesize the standard cell, and the resulting cells may be tested at various levels in the design pipeline to identify the most efficient implementation in terms of PPA and/or other metrics. For example, the resulting standard cell may be tested on its own against specific standard cell benchmarks or optimization parameters 116. Alternatively, the resulting standard cell may be integrated into larger designs, such as AI or system-on-a-chip (SoC) processors, and these larger designs may then be tested to evaluate the effect of the standard cells. Based on these simulations or tests, the tool 101 may select the best layout 114 generated from one of the selected sets of slices to identify the resulting final layout 118 for the design.

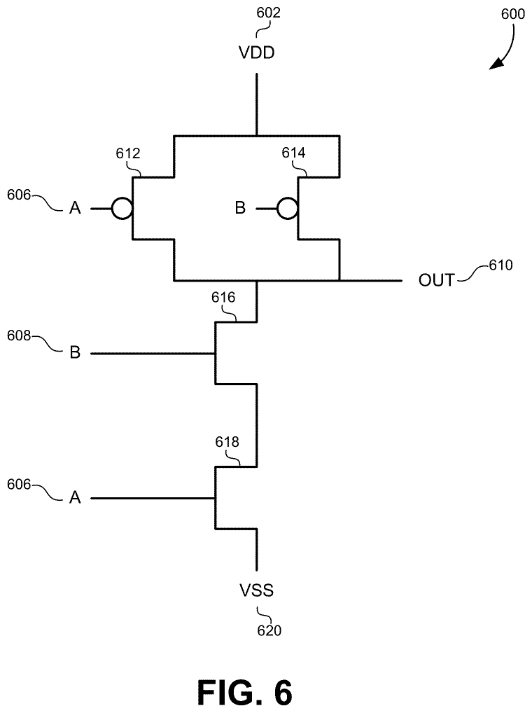

FIG. 6 illustrates a schematic of a circuit 600 used for a standard cell, according to some embodiments. This circuit 600 is more complex than the circuit 200 illustrated above for the inverter. This circuit 600 will be used in the following sections to describe specifically how a set of slices may be selected, and how these sets of selected slices may be optimized when forming candidate layouts for the standard cells. The circuit 600 may include a first input 606, a second input 608, and an output 610. The circuit 600 may also include a VDD input 602 and a VSS input 620. The devices used in the circuit 600 may include transistors 612, 614, 616, 618. Note that this circuit 600 is provided only by way of example and is not meant to be limiting. A corresponding definition of the circuit for the standard cell may be stored as a netlist, such as the following.

.SUBCKT NAND2 A B OUT VSS VDD
T0 VDD A OUT VDD pfet W=1.0 L=1.0 nfin=2
T1 VDD B OUT VDD pfet W=1.0 L=1.0 nfin=2
T2 VSS A n1 VSS nfet W=1.0 L=1.0 nfin=2
T3 n1 B OUT VSS nfet W=1.0 L=1.0 nfin=2
.ENDS

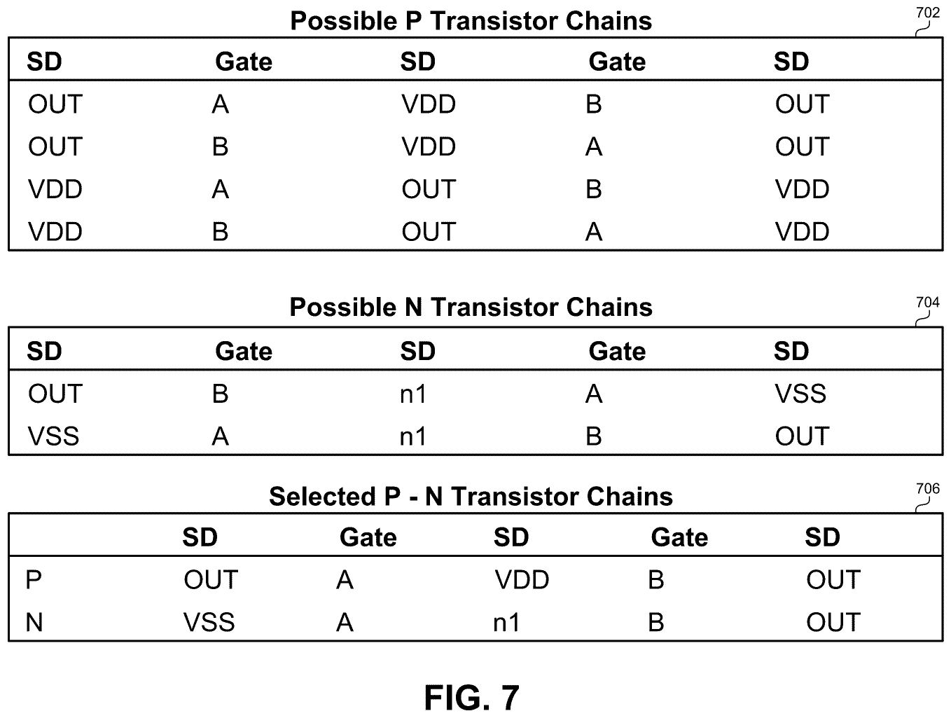

FIG. 7 illustrates possible device chains that may be derived from the circuit 600, according to some embodiments. In this example, the device chains include transistor chains for each branch or type of transistor. For example, the possible transistor chains 702 illustrate four different chains of connections that may be made through the P transistors 612, 614 of the circuit 600. For example, each of the possible transistor chains 702 may use a different starting/ending location and may traverse around the P transistors 612, 614 in a different direction (e.g., clockwise or counterclockwise). Similarly, the possible transistor chains 704 illustrate two different chains of connections that may be made through the N transistors 616, 618 of the circuit 600. Each of these possible transistor chains 704 may traverse the N transistors 616, 618 in a different direction (e.g., up or down).

The tool 101 may select from the possible transistor chains 702, 704 to identify an optimal combination of transistor chains from each group to implement the standard cell. For example, the selected transistor chains 706 may choose from each group of the possible P transistor chains 702 and the possible N transistor chains 704. In some embodiments, the tool 101 may be configured to select transistor chains that results in the most matching connections. For example, the selected transistor chains 706 in FIG. 7 match the input signals on the gates and the SD output.

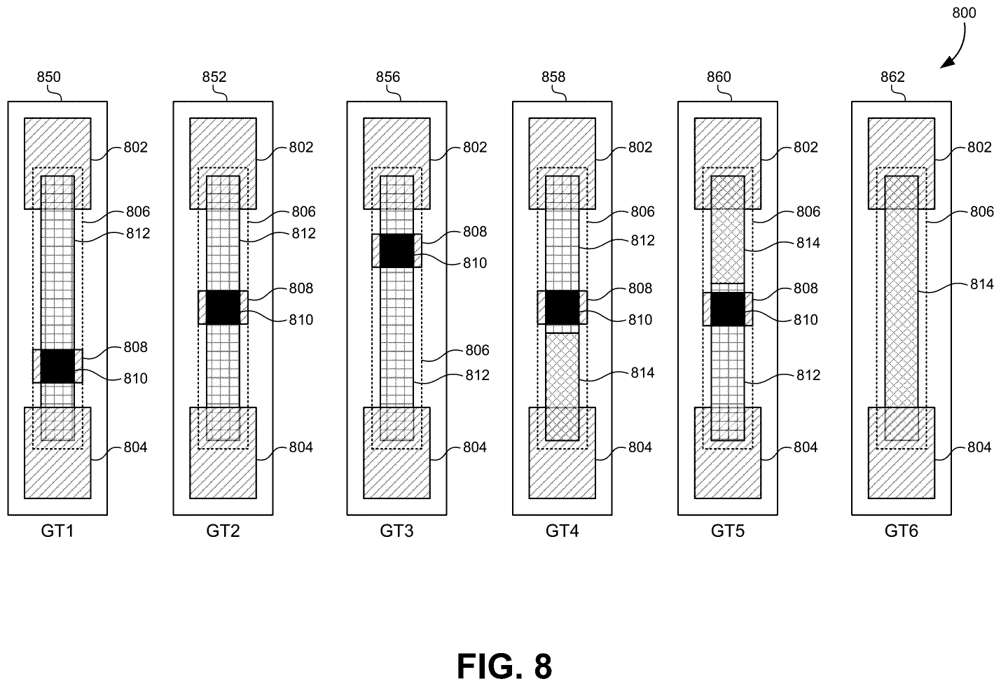

FIG. 8 illustrates candidate gate slices 800 that may be used to implement the selected transistor chains 706, according to some embodiments. Similar to the examples above, the candidate gate slices 800 may represent partial layouts of transistors. The candidate gate slices 800 may specifically include connections made to the gate regions of the transistors. Note that the slices alone do not represent functional circuits or functional devices, but instead may be used as building blocks with the partial layouts of other slices to form functional devices and ultimately the standard cell itself.

Each of these candidate gate slices 800 may include an alignment shape 806 as described above, a VDD region 802, a VSS region 804, a gate region 812 which may be formed as a trench contact connecting the transistor epi silicon to metal layer contacts, a metal layer contact 110 (e.g., a via), and a corresponding metal contact 808 in the metal layer. Each of the candidate gate slices 800 may make a connection to a different signal track in the upper metal layer. For example, slice 850 may connect to a first signal track, slice 852 may connect to a second signal track, and slice 856 may connect to a third signal track. Some slices may also divide the trench gate region 812 into two halves. For example, a trench cut layer 814 may separate the trench contact of the gate region 812. Slice 858 may include a connection to the second signal track for one side of the gate region 812, while slice 860 may include a connection to the second signal track for the other side of the gate region 812. Slice 862 may include a dummy gate that is not connected to the upper metal layer.

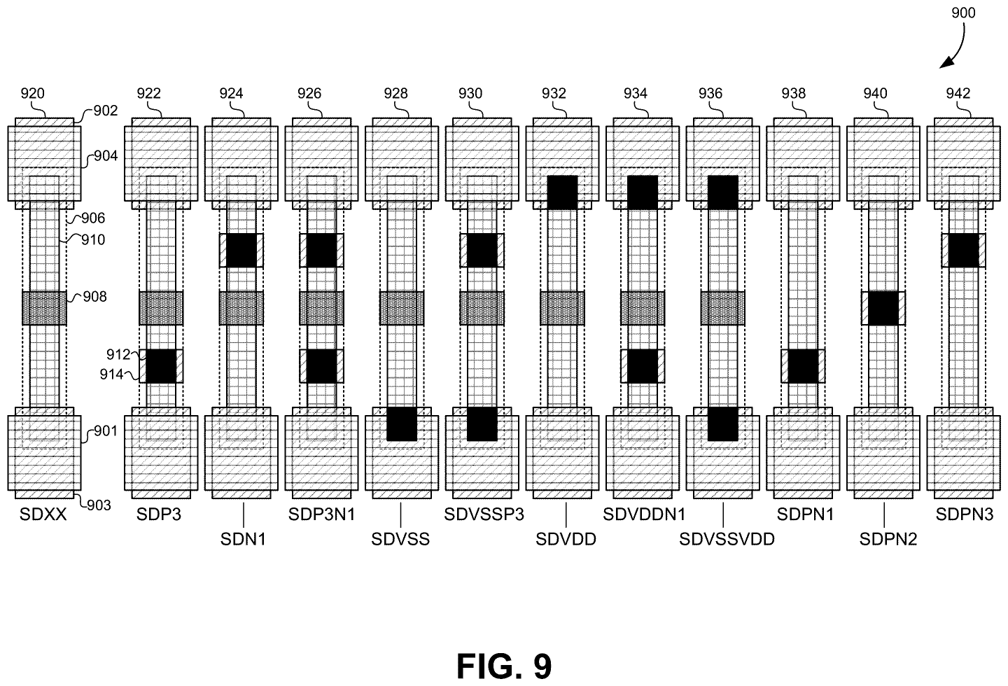

FIG. 9 illustrates candidate SD slices 900 that may be used to implement the selected transistor chains 706 according to some embodiments. Each of the candidate SD slices 900 may include a VDD region 904, a VSS region 901, a PSD region 902, an NSD region 903, an alignment shape 906, an SD connection 910, (optionally) an SD cut layer to separate the source and drain, a metal layer contact 912 (e.g., a via), and a corresponding metal contact 914 in the metal layer.

The specific connections and configurations for each of these different slices are illustrated in FIG. 9. For example, slice 920 may represent a slice where the source and drain regions are not connected to signals in the metal layer or to VSS/VDD tracks. Instead, the source drain regions may be connected by abutting to adjacent source or drain regions of adjacent devices. Slice 922 may include an NSD connection to a third signal track, slice 924 may include a PSD connection to a first signal track, and slice 926 may include connections to both of these signal tracks. Slices 928 and 930 may include a PSD connection to VSS with an optional connection to the first signal track. Slices 932 and 934 may include an NSD connection to VDD with an optional connection to the third signal track. Slice 936 may include connections to VDD and VSS. Slices 938, 940, and 942 may include combined PSD and NSD connections to each of the three signal tracks.

For each of the selected transistor chains 706, the tool may identify possible SD slices and gate slices from the layouts illustrated in FIGS. 8-9. These slices may then be optimized and combined together to form the final layout of the circuit 600.

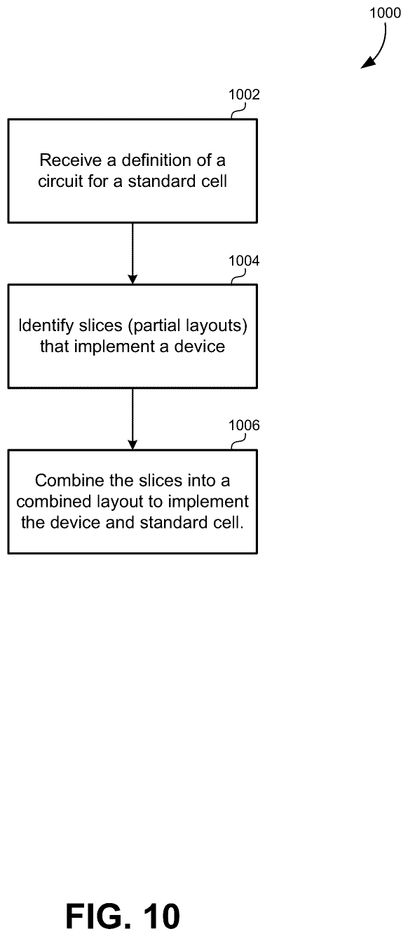

FIG. 10 illustrates a flowchart 1000 of a method of automatically generating standard cells, according to some embodiments. The method may include receiving a definition of a circuit for a standard cell (1002). The circuit may include one or more semiconductor devices. As described above, these devices may include functional building blocks (e.g., transistors, diodes, etc.) that may be combined together to form the standard cell. The circuit may be defined or represented by a netlist or other representation.

The method may also include identifying a plurality of slices that implements a device in the one or more semiconductor devices of the standard cell (1004). As described above, slices may represent partial layouts for each of the devices. These partial layouts may be nonfunctional on their own, but may be combined to form the functioning devices. Partial layouts may include layouts for source/drain regions, layouts for gate regions, and/or other regions for various devices. For example, the plurality of slices may include a first set of slices that each implement a partial layout differently (e.g. using different source/drain connections). Different implementations may connect to different intersecting signal tracks in an overlying metal layer. In some embodiments, the definition of the circuit for the standard cell may be used to identify device chains, such as transistor chains, and an optimal device chain may be selected for implementation as described above. The device chain the represent connections between devices and between inputs and outputs in the standard cell. A set of possible slices may then be identified to implement each of the nodes or connections in the device chains. Therefore, each slice may include a partial layout that may implement parts of multiple devices. For example, a slice implementing source/drain connections may implement a source/drain connection for a plurality of transistors. Conversely, a slice implementing a gate connection may be used to implement a partial layout for a single transistor. This same procedure may be carried out for each device in the standard cell.

This set of possible slices may be optimized, and the remaining sets of slices may then be combined into a combined layout to implement the device and other devices when forming the standard cell (1006). The combination of slices in the combined layout may include the slices with the partial layouts used implement the device (and possibly other devices simultaneously) described above. The combination slices may also include other slices with partial layouts that implement the remaining devices in the standard cell. Therefore, the partial layouts of the slices for a single device may be only part of the combination of slices used to generate the combined layout.

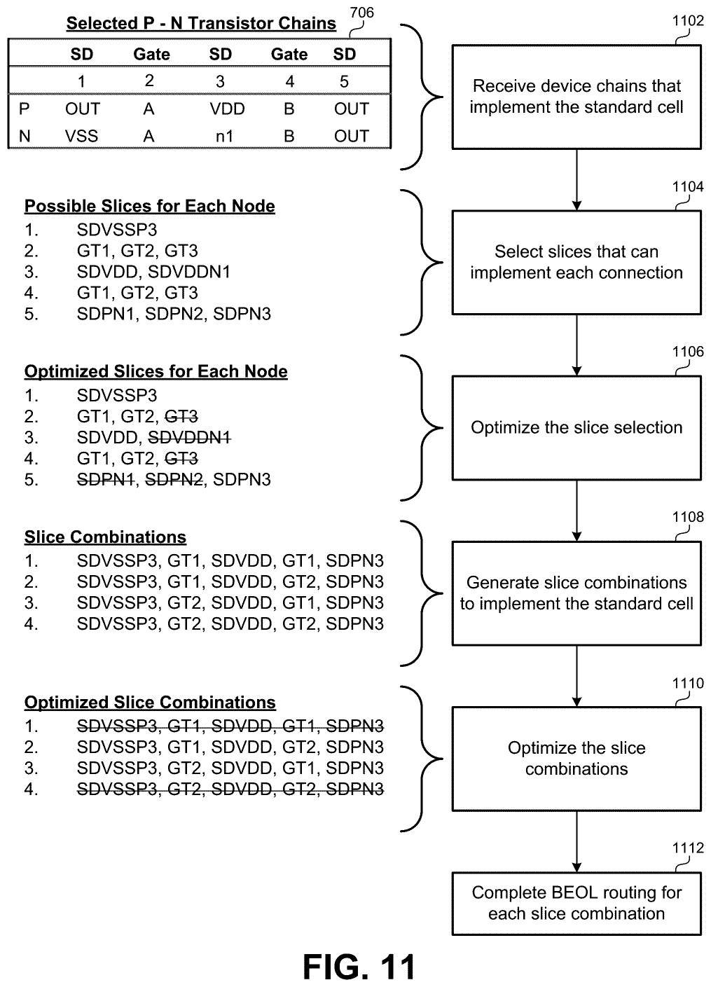

FIG. 11 illustrates a flowchart of operations that may be used to select and optimize a set of slices used to implement the standard cell, according to some embodiments. The method may include receiving device chains that implement the standard cell (1102). These operations may be performed after the selected device chains 706 have been identified and chosen as described above in FIG. 7. As illustrated in FIG. 11, each connection for the devices in the device chains (e.g., sources, drains, gates, etc.) may be considered a node in the circuit. As described above, the device chains may be selected in order to maximize nodes with common connections for each device chain.

The method may include selecting a set of candidate slices from a slice library that can be used in each of the connections (1104). As illustrated in FIG. 11, possible slices for each node may be selected by identifying nodes that can possibly make the required connections. For example, the (SDVSSP3) slice 930 in FIG. 9 may be used to implement connection at node 1 since it includes a connection to VSS and a signal track on the metal layer that can be used as the output. In another example, any of the gate slices 850, 852, 856 may be used to implement node 2 and node 4, since these nodes only require a connection to an output signal in the metal layer. The set of possible slices that may be used to implement each of the other connections may be identified in a similar manner.

The method may also include optimizing the slice selections for each node (1106). For example, the total Cartesian product of the possible slices for each node identified in operation 1104 may include 54 possible slice sequences. In order to optimize these slice selections for each node, signals may be assigned to signal tracks in the metal layer and the compatibility of each possible slice may be determined. For example, track 3 must be assigned to the output since this is the only track available for the SDVSSP3 slice 930. This effectively eliminates slices GT3, SDPN1, and SDPN2 since these slices either connect the output to other tracks or connect other signals to the output track. Thus optimizations can be made by limiting slices that have conflicting connections to tracks in the metal layer.

Another optimization method may include identifying internal connections that do not require connections to be made in the metal track. For example, slice SDVDDNI may be eliminated since the nl node that internally connects the two PFETs does not need to be connected to other nodes through the metal layer. Instead, this connection can be facilitated by connecting these slices together using an SD adjacent abutment as described above. This allows the tool to optimize the set of candidate slices for each node by limiting slices that can be implemented by placing two slices adjacent to each other.

The method may further include generating slice combinations to implement the standard cell (1108). The Cartesian product of the remaining possible slices for each node may be combined to form one or more combination slices from the set of candidate slices. Each of these combinations may individually implement the standard cell. The method may then include optimizing the slice combinations based on design rules for the metal layer (1110). The first and fourth slice combinations in FIG. 11 can be eliminated since using GT1 or GT2 exclusively for both gates will lead to a collision the metal layer of these two input signals. The remaining two slice combinations use GT1 for one input, and GT2 for the other input.

The method may additionally include completing the BEOL routing for each of the remaining slice combinations (1112). As described above, some embodiments may fully implement a plurality of different layout options for the standard cell. These different options may be simulated and tested at various levels of the design pipeline in order to identify a standard cell that provides optimal testing results. For example, the standard cell with the best cost or best PPA score may be chosen as the final result for the standard cell.

The operations described in FIG. 10 and FIG. 11 may be carried out for different implementations of different devices. One of the many technical advantages provided by these embodiments allows standard cell designers to readily swap device technologies and synthesize the resulting standard cells automatically instead of manually. For example, turning back to FIG. 1, the library of slice definitions 108 may be replaced with another slice library that includes different implementations for slices for a device in the device chain. For example, a transistor defined by a first library may include a MOSFET with various source/drain and gate slices. A second library may include another transistor type, such as a finFET with corresponding source/drain slices and gate fin slices. Since the interfaces for the slices will remain the same (e.g., a gate, a source, a drain) the underlying implementation details may be contained within the slices themselves. Thus, the tool 101 can run the same process described above on both of the different device types in different slice libraries to rapidly generate different implementations of the standard cell.

It should be appreciated that the specific steps illustrated in FIG. 10-11 provide particular methods of automatically generating standard cells according to various embodiments. Other sequences of steps may also be performed according to alternative embodiments. For example, alternative embodiments may perform the steps outlined above in a different order. Moreover, the individual steps illustrated in FIGS. 10-11 may include multiple sub-steps that may be performed in various sequences as appropriate to the individual step. Furthermore, additional steps may be added or removed depending on the particular applications. Many variations, modifications, and alternatives also fall within the scope of this disclosure.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

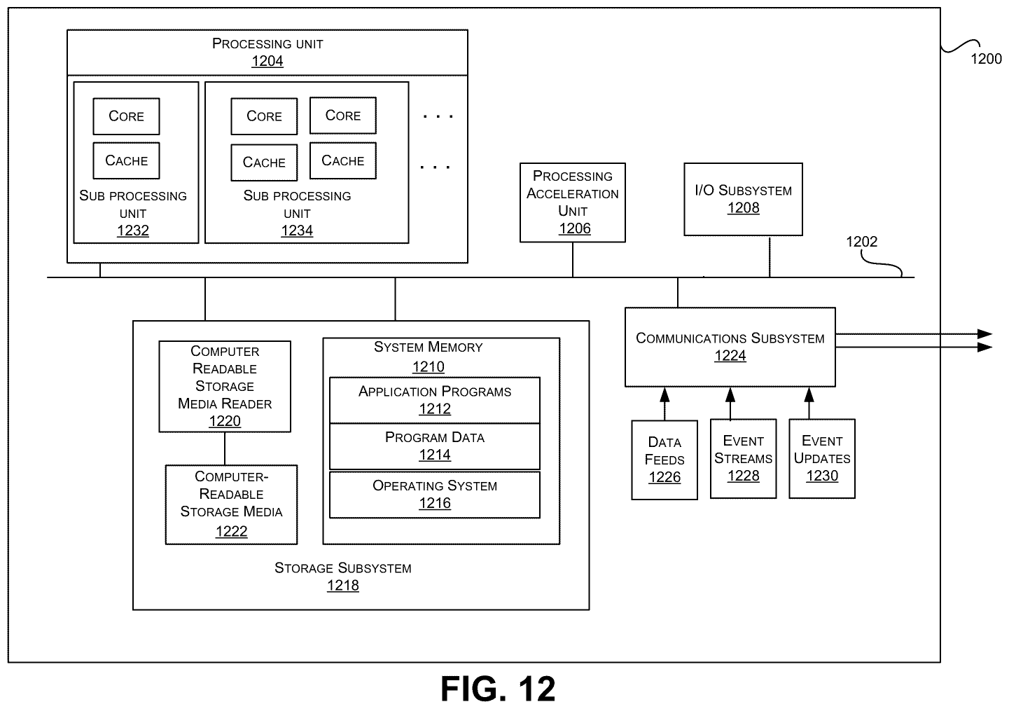

FIG. 12 illustrates an exemplary computer system 1200, in which various embodiments may be implemented. The system 1200 may be used to implement any of the computer systems described above. For example, the computer system 1200 may be used to perform the methods described above in FIG. 10 in FIG. 11. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that comprises software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 1218 may also provide a tangible computer-readable storage medium for storing the basic programming and data constructs that provide the functionality of some embodiments. Software (programs, code modules, instructions) that when executed by a processor provide the functionality described above may be stored in storage subsystem 1218. These software modules or instructions may be executed by processing unit 1204. Storage subsystem 1218 may also provide a repository for storing data used in accordance with some embodiments.

Storage subsystem 1200 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

As used herein, the terms “about” or “approximately” or “substantially” may be interpreted as being within a range that would be expected by one having ordinary skill in the art in light of the specification.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of automatically generating standard cells, the method comprising:
receiving, by a computer system, a definition of a circuit for a standard cell, wherein the circuit comprises one or more semiconductor devices;
identifying, by the computer system, a plurality of slices that implement a device in the one or more semiconductor devices, wherein each of the plurality of slices comprises a partial layout for the device; and
combining, by the computer system, more than one of the plurality of slices into a combined layout to implement the device when forming the standard cell.

2. The method of claim 1, wherein the device comprises a functional circuit element.

3. The method of claim 2, wherein the partial layouts are not functional circuit elements, and the combined layout forms the functional circuit element.

4. The method of claim 2, wherein a slice in the plurality of slices includes partial layouts for more than one of the one or more semiconductor devices, and wherein the combined layout comprises additional slices that together with the more than one of the plurality of slices implement the one or more semiconductor devices for the standard cell.

5. The method of claim 1, wherein:
a first slice in the plurality of slices comprises a first partial layout for the device; and
a second slice in the plurality of slices comprises a second partial layout for the device.

6. The method of claim 5, wherein the first partial layout comprises a layout of a source region or a drain region of a transistor.

7. The method of claim 5, wherein the second partial layout comprises a layout of a gate region of a transistor.

8. A system comprising:
one or more processors; and
one or more memory devices comprising instructions that, when executed by the one or more processors, cause the one or more processors to perform operations comprising:
receiving a definition of a circuit for a standard cell, wherein the circuit comprises one or more semiconductor devices;
identifying a plurality of slices that implement a device in the one or more semiconductor devices, wherein each of the plurality of slices comprises a partial layout for the device; and
combining more than one of the plurality of slices into a combined layout to implement the device when forming the standard cell.

9. The system of claim 8, wherein:
the plurality of slices comprises a first set of slices that each comprises a different implementation of a first partial layout for the device; and
the operations further comprise selecting a first slice from the first set of slices for the device.

10. The system of claim 9, wherein:
the first slice comprises a connection to a first intersecting track in a metal layer; and
a second slice in a second set of slices for the device comprises a connection to a second intersecting track in the metal layer.

11. The system of claim 8, wherein the operations further comprise:
determining one or more device chains for generating a cell layout for the standard cell, wherein the one or more device chains represent connections between devices in the one or more semiconductor devices and inputs and/or outputs in the standard cell.

12. The system of claim 11, wherein the operations further comprise:
selecting a set of candidate slices from a slice library that can be used to implement each of the connections.

13. The system of claim 12, wherein the operations further comprise:
assigning tracks in a metal layer to the inputs/outputs in the standard cell;
optimizing the set of candidate slices by eliminating slices that can be implemented by placing two slices adjacent to each other; and
optimizing the set of candidate slices by eliminating slices that have conflicting connections to the tracks in the metal layer.

14. The system of claim 13, wherein the operations further comprise:
generating one or more combinations of slices from the set of candidate slices that each implement the standard cell.

15. The system of claim 14, wherein the operations further comprise:
optimizing the one or more combinations of slices based on design rules for the metal layer, wherein the one or more combinations of slices comprise the plurality of slices for the device after optimization.

16. One or more non-transitory computer-readable media comprising instructions that, when executed by one or more processors, cause the one or more processors to perform operations comprising:
receiving a definition of a circuit for a standard cell, wherein the circuit comprises one or more semiconductor devices;
identifying a plurality of slices that implement a device in the one or more semiconductor devices, wherein each of the plurality of slices comprises a partial layout for the device; and
combining more than one of the plurality of slices into a combined layout to implement the device when forming the standard cell.

17. The one or more non-transitory computer-readable media of claim 16, wherein the definition of the circuit comprises a netlist with device characteristics and connections between the one or more semiconductor devices.

18. The one or more non-transitory computer-readable media of claim 16, wherein the operations further comprise:
accessing a first slice library for the device to retrieve the plurality of slices, wherein the first slice library comprises partial layouts for different implementations of a first device type for the device.

19. The one or more non-transitory computer-readable media of claim 18, further comprising a second slice library for the device, wherein the second slice library comprises partial layouts for different implementations of a second device type for the device.

20. The one or more non-transitory computer-readable media of claim 19, wherein the device comprises a transistor, the first device type comprises a metal-oxide-semiconductor field-effect transistor (MOSFET), and the second device type comprises a fin field-effect transistor (finFET).
